(19) United States
(12) Patent Application Publication
(10) Pub. No.: US 2024/0310824 A1
(43) Pub. Date: Sep. 19, 2024

(54) MACHINE LEARNING-BASED INCIDENT REPORT CLASSIFICATION

(71) Applicant: Jensen Hughes, Inc., Baltimore, MD (US)

(72) Inventors: Jonathan L. Hodges, Blacksburg, VA (US); Stephen M. Hess, West Chester, PA (US); Andrew P. Miller, West Chester, PA (US)

(21) Appl. No.: 18/608,295

(22) Filed: Mar. 18, 2024

Related U.S. Application Data
(60) Provisional application No. 63/453,294, filed on Mar. 20, 2023.
(60) Provisional application No. 63/452,954, filed on Mar. 17, 2023.

(51) Int. Cl. G05B 23/02; G06V 30/19

(52) U.S. Cl. CPC G05B 23/0272; G06V 30/1916

(57) ABSTRACT

A method for monitoring an industrial facility divides an incident report into text portions. The method determines text confidence values to the text portions. The method determines a report characteristic including a non-textual data type for the incident report. The method trains a neural network model. The method inputs the text confidence values and the report characteristic into the neural network model. The method outputs a network confidence value from the neural network model in response to inputting the text confidence values and the report characteristic.

### PRIORITY

This patent application claims priority from provisional U.S. patent application No. 63/453,294, filed Mar. 20, 2023, entitled, “MACHINE LEARNING-BASED INCIDENT REPORT CLASSIFICATION,” and naming Jonathan L. Hodges et al. as inventors, and provisional U.S. patent application No. 63/452,954, filed Mar. 17, 2023, and entitled, “USER INTERFACE FOR INDUSTRIAL PLANT MANAGEMENT,” and naming Andrew P. Miller et al. as inventors, the disclosures of which is incorporated herein, in its entirety, by reference.

### FIELD

Illustrative embodiments of the invention generally relate to incident report monitoring and, more particularly, various embodiments of the invention relate to classifying incident reports using machine learning.

### BACKGROUND

Incident reports may be used to maintain, among other things, industrial facilities by indicating whether a facility is experiencing normal or abnormal conditions. As the number of incident reports increases, operators may be overwhelmed by the volume of incident reports to review, not having sufficient time to review all incident reports and identify potentially hazardous abnormal conditions at the facility.

### SUMMARY OF VARIOUS EMBODIMENTS

In accordance with one embodiment of the invention, a method for monitoring an industrial facility divides an incident report into text portions. The method determines text confidence values to the text portions. The method determines a report characteristic including a non-textual data type for the incident report. The method trains a neural network model. The method inputs the text confidence values and the report characteristic into the neural network model. The method outputs a network confidence value from the neural network model in response to inputting the text confidence values and the report characteristic.

Assigning the plurality of text confidence values may include dividing one of the plurality of text portions into a plurality of phrases; determining a plurality of abnormal condition scores to the plurality of phrases; and determining the text confidence value for the one text portion using the abnormal condition scores.

Determining the report characteristic includes the non-textual data type may include determining the report characteristic using the incident report. The non-textual data type may include at least one of a Boolean value, a categorical value, or an identification value.

In some embodiments, the method determines a flag status for the incident report after comparing the network confidence value and a flag threshold, and comparing the plurality of text confidence values and a plurality of flag thresholds.

In some embodiments, the method determines a flag status of the incident report using a weighted expression or a logical expression including the network confidence value and the plurality of text confidence values.

In some embodiments, the method generates a user interface including a plurality of visual representations corresponding to the plurality of text confidence values and the network confidence value, each visual representation indicating a flag status of the corresponding confidence value.

Training the neural network model may use historical text confidence values, historical report characteristics, and historical network confidence values.

Assigning the plurality of text confidence values to the plurality of text portions may include using a Bayesian confidence score.

In some embodiments, the method determines a plurality of report characteristics, each including a non-textual data type, at least one of the report characteristics being a non-normalized numerical value, at least one of the report characteristics being a normalized numerical value, and at least one of the report characteristics being a categorical value represented by one hot encoding.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a user interface in accordance with various embodiments.

FIG. 2 shows a process for monitoring an industrial facility.

FIG. 3 schematically shows a computing device in accordance with various embodiments.

### DESCRIPTION OF ILLUSTRATIVE EMBODIMENTS

In illustrative embodiments, an incident report management system analyzes and flags incident reports based on scores of metrics derived from analyzing text sections of the incident report, among other things. An incident report may be a written report of a worksite event, among other things. An incident report may detail an event causing or nearly causing damage to person or property at a worksite, such as an industrial facility, among other things. Incident reports may be used in industrial facilities such as government facilities, military facilities, mission critical facilities, power plants (e.g., nuclear power plants), power transmission and distribution systems, schools, research facilities, manufacturing facilities, construction sites, hotels, airports, petrochemical processing plants, and health care facilities, among other things. Details of illustrative embodiments are discussed below.

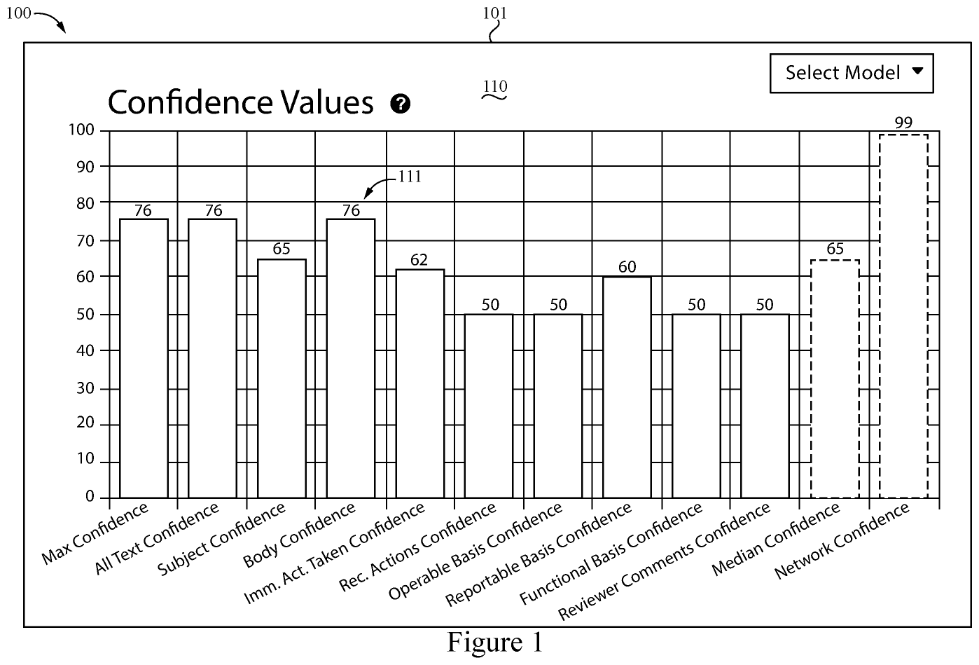

FIG. 1 schematically shows a user interface 100 configured to display the analysis of an incident report. The interface 100 is displayed on a screen 101 of an incident report management system configured to analyze the incident report and determine whether the incident report should be flagged.

The user interface 100 includes a graph 110 configured to present results of the analysis used to determine whether to flag the report. The graph 110 includes a plurality of confidence values 111 represented by bar graphs of a solid line and bar graphs of a dashed line. Among other things, a confidence value may be a score indicating a likelihood the incident report corresponds to a worksite event requiring further action or review, also known as an abnormal condition. Each confidence value 111 may a score within a range of values, such as a range between 0 and 100. A confidence value 111 of zero may indicate strong confidence the incident report should not be flagged. A confidence value of 100 may indicate strong confidence that the incident report should be flagged. A confidence value of 50 may indicate no confidence in whether the incident report should be flagged. For example, portions of an incident report with no words may have a confidence value of 50, because there are no words to evaluate.

It should be appreciated that the confidence values 100 may indicate more than abnormal conditions or normal conditions. The confidence values may relate to a selection of one or more options. For example, confidence values may relate to record routing, where the one condition is routing to one database, and a second condition is routing to a second database.

The confidence values are labeled along the x-axis of the graph 110. Some of the confidence values are text confidence values, including confidence values corresponding to text portions of the incident report. An incident report may be divided into sections by headings, among other things. In some embodiments, the incident report may be divided using a template of headings, for which some of the headings may have no corresponding text section. For example, the illustrated embodiment includes the following text confidence: a subject confidence value corresponding to a text portion under a subject heading; body confidence value corresponding to a text portion under a body heading; an immediate action taken confidence value corresponding to a text portion under an immediate action taken heading; a recommended actions confidence value corresponding to a text portion under a recommended actions heading; an operable basis confidence value corresponding to a text portion under an operable basis heading; a reportable basis confidence value corresponding to a text portion under a reportable basis heading; a functional basis confidence value corresponding to a text portion under a functional basis heading; and a reviewer comments confidence value corresponding to a text portion under a review comments heading. The text confidence values also include an all text confidence value corresponding to a score given for the entire text of the incident report.

Some of the confidence values 111 correspond to statistical analysis of the text confidence values and the all-text confidence value. For example, the confidence values 111 include a maximum confidence value equal to the maximum text confidence value. In the illustrated embodiment, the maximum confidence value is 76 because the high value of the text confidence values (all text confidence value and body confidence values) is 76. The confidence values 111 also include a median confidence value equal to the median of the text confidence values. In the illustrated embodiment, the median confidence value is 65 because the subject confidence value is the median of all the text confidence values.

The confidence values 111 also include a network confidence value corresponding to analysis of the incident report performed by a neural network. In some embodiments, the network confidence value is an output of the neural network.

Each confidence value 111 has a corresponding threshold to which it is compare to determine whether the confidence value 111 indicates whether the incident report should be flagged. When the confidence value 111 is greater than its corresponding threshold, the incident report may be flagged. When the confidence value is less than or equal to its corresponding threshold, the incident report may not be flagged for review on the basis of the particular confidence value. Each threshold may be set to balance a ratio of false flagging positives (i.e., incident report is flagged although there is not abnormal condition) and false flagging negatives (i.e., incident report is not flagged although there is an abnormal condition).

The confidence values 111 indicating the incident report should not be flagged for review may be marked with a common visual indicator. In the illustrated embodiment, the confidence values indicating the incident report should be flagged are marked with dashed lines and the remaining confidence values not indicating the incident report should be flagged for review are marked with solid lines. In some embodiments, the flag status may be indicated by other visual indicators, such as a color, among other things. In the illustrated embodiment, the first ten confidence values do not exceed their corresponding thresholds, and are therefore marked to indicate they are not the basis for the incident report being flagged for review. The last two confidence values (the median confidence value and the network confidence value) exceed their corresponding thresholds, and are therefore marked to indicate they are the basis for the incident report being flagged for review.

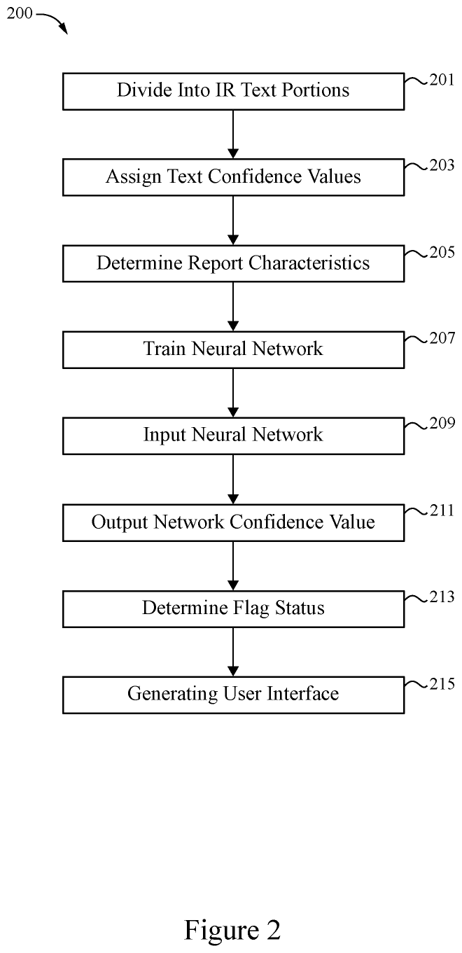

FIG. 2 shows an exemplary process 200 for monitoring an industrial facility in accordance with various embodiments. The process 200 may be implemented in whole or in part in one or more of the incident report management systems disclosed herein. In certain forms, the functionalities may be performed by separate devices of the system, such as a local computing device and a remote server, among other things. In certain forms, all functionalities may be performed by the same device. It should be further appreciated that a number of variations and modifications to process 200 are contemplated including, for example, the omission of one or more aspects of process 200, the addition of further conditionals and operations, or the reorganization or separation of operations and conditionals into separate processes.

Process 200 begins by dividing an incident report into text portions in operation 201. The incident report may be divided by headings, among other things. In some embodiments, the incident report is divided according to a template of headings such that sometimes a heading may have not corresponding text portion from the incident report.

Process 200 then assigns text confidence values to the text portions of the incident report in operation 203. To assign a text confidence value to a text portion, operation 203 may first assign scores to words or phrases of the text section. For example, each text portion may be divided into words or phrases. Some or all of the words/phrases may be assigned a score corresponding to a likelihood the inclusion of the word/phrase in the incident report indicates the incident report should be flagged for review, also known as an abnormal condition score or, generally, a condition score. Some or all of the words/phrases may be assigned a score corresponding to a likelihood the inclusion of the word/phrase in the incident report indicates the incident report should not be flagged for review, also known as a normal condition score or, generally, a condition score. In other embodiments, words or phrases may be assigned scores corresponding to the likelihood the inclusion of the word/phrase in the incident report indicates a condition.

The abnormal condition score and/or the normal condition score may be determined by analyzing the frequency of the word/phrase in historical incident reports that correctly identified an abnormal condition or a normal condition, among other things.

After the process 200 determines the condition scores, operation 203 may assign confidence values for each text portion using the condition scores corresponding to the words/phrases within the text portion. In some embodiments, the confidence value may be assigned using Bayesian inference. The confidence value may be calculated for each output field for each condition value with respect to each potential other condition value. This calculation may be according to the equation below, where α is the first condition score (i.e. normal/abnormal condition score or other type of condition score), β is the second condition score (i.e. normal/abnormal condition score or other type of condition score), C is the confidence value, and P is the probability of the indicated categorical value from the training data.

$${C}_{α - β} = 0.5 + ( \frac{1}{π} ) \times atan [ ln ( \frac{P ( α )}{P ( β )} ) ] \qquad ( 1 )$$

Process 200 determines report characteristics of a non-textual data type in operation 205. The report characteristics are data about the incident report which are derived from the incident report or a combination of the incident report and an external data source.

The types of non-textual data correspond to data having a type other than free form text. A report characteristic may include a binary value or Boolean value which indicates one of two possible states, such as the answer to a yes or no question, among other things. For example, a binary/Boolean value may correspond to whether equipment was operable after the incident; whether the event requires an immediate review; or whether the incident represents a reportable incident, among other things.

A report characteristic may include a categorical value which indicates one or more of two or more possible options. For example, a category may include, among other things, a type of equipment, critical equipment class, keyword relevant to the IR, equipment group, a nature of the IR, or a safety class of the equipment.

A report characteristic may include an identifier value configured to identify a user, a piece of equipment, a component, a process, or a building, among other things.

A report characteristic may include a ground truth value, which may be a specific data field not included in one of the other report characteristics. These values may be predicted by the system. For example, a ground truth value may include a type of incident report determined by a corrective action program metric; an investigation class; or a flag from another metric under which the incident report was evaluated.

A report characteristic may include a numerical value. For example, a report characteristic may be a word count, among other things. In some embodiments, a numerical value may be a selection of interrelated categories. For example, a numerical value may be a severity level from corresponding operating procedures, where category 1 is worse than category 5.

A report characteristic may include a flag status or confidence values from another metric of the same incident report. The report characteristics may not include the text confidence values derived in operation 203 which are used as input for the machine learning model. That is to say, the text confidence values derived to score the present incident report being evaluated may not be included in the report characteristics.

Before the report characteristics are used in one of the other operations of process 200, such as the neural network related operations, some or all of the report characteristics may be pre-processed, which may include normalizing numerical values, or converting a value to one hot encoding, among other things. For example, a severity level may be normalized, while numerical equipment identifiers may be one hot encoded rather than normalized.

The incident report may be evaluated using individual text confidence values or report characteristics. Additionally, process 200 evaluates the incident report by synthesizing text confidence values and report characteristics using a machine learning model. In operation 207, process 200 trains a neural network using a training data set derived from historical incident reports. The training data set may include both historical confidence values and historical report characteristics, along with a corresponding outcome (abnormal state/normal/other condition, among other things).

In some embodiments, the neural network includes a plurality of intermediate layers. The number of nodes of the neural network may depend on the ratio of normal to flagged incident reports in the training data.

Once the neural network is trained, process 200 may input data corresponding to the incident report into the machine learning model and receive the network confidence value as output from the machine learning model. In operation 209, process 200 inputs data including both text confidence values and at least one report characteristic into the neural network trained during operation 207.

The neural network uses the input data to determine the network confidence value, which the neural network outputs in operation 211. The network confidence indicates the confidence that the neural network has that the incident report should/should not be flagged for review.

Process 200 may then determine a flag status for the incident report in operation 213. Determining the flag status may include using the confidence values and/or the report characteristics. For example, determining a flag status for the incident report may include evaluating a weighted expression or a logical expression including the network confidence value and at least a portion of the plurality of text confidence values.

In some embodiments, operation 213 may use a logical expression comparing the confidence values determined in operations 203 and 211 to value-specific thresholds set by a user or by the incident report management system. The thresholds may be set such that if one confidence value exceeds its corresponding threshold, the flag status indicates the incident report should be flagged for review. Since each confidence value has its own threshold, it should be appreciated that the thresholds may differ in value.

In some embodiments, the thresholds may be tuned to maintain a balance (ratio) between false flag positives and false flag negatives. Adjusting the sensitivity of the threshold may be done in response to one or more sensitivity assessments. The sensitivity assessments may include performing variations of different steps or substeps of the process 200 for a number of iterations and evaluating the output of the neural network and/or the flag status. These assessments may include selecting multiple random seeds for the neural network; adjusting the intermediate layers of the neural network; adjusting the availability of the data inputs; splitting training data into training data, testing data, validation data, then adjusting the ratio of training data to testing data to validation data; and adjusting the weights of a weighted expression to determine flag status or adjusting variables or other aspects of logical expressions to determine flag status.

After determining one or more of the flag status, the text confidence values, or the network confidence value, process 200 may generate an incident report user interface in operation 215. Among other things, the incident report user interface may include a visual representation of a graph of confidence values such as the graph illustrated in FIG. 1. As in FIG. 1, the visual representations of the confidence values may be marked to indicate whether the confidence value was a basis for flagging the incident report for user review.

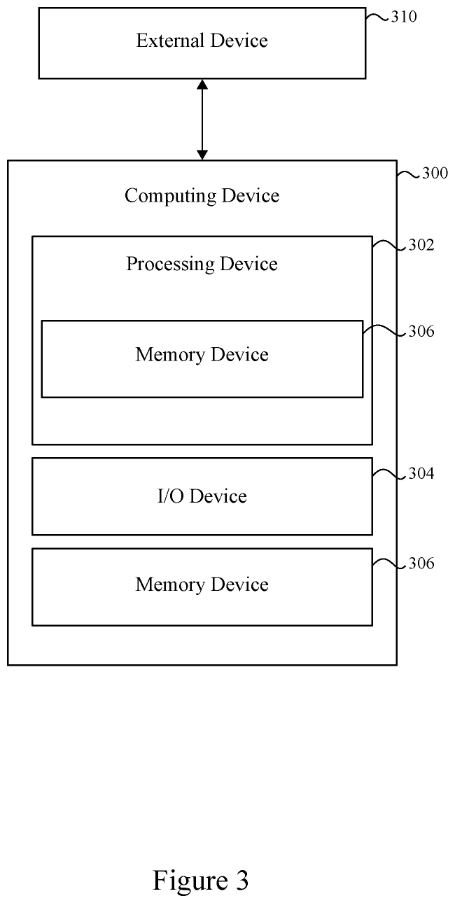

FIG. 3 schematically shows a computing device 300 in accordance with various embodiments. The computing device 300 is an example of an incident report management system configured to display the user interface 100 and perform one or more operations of the process 200 illustrated in FIG. 2. The computing device 300 includes a processing device 302, an input/output device 304, and a memory device 306. The computing device 300 may be a stand-alone device, an embedded system, or a plurality of devices configured to perform the functions described herein. Furthermore, the computing device 300 may communicate with one or more external devices 310. The input/output device 304 enables the computing device 300 to communicate with an external device 310. For example, the input/output device 304 may be a network adapter, a network credential, an interface, or a port (e.g., a USB port, serial port, parallel port, an analog port, a digital port, VGA, DVI, HDMI, Fire Wire, CAT 5, Ethernet, fiber, or any other type of port or interface), among other things. The input/output device 304 may be comprised of hardware, software, or firmware. The input/output device 304 may have more than one of these adapters, credentials, interfaces, or ports, such as a first port for receiving data and a second port for transmitting data, among other things.

The external device 310 may be any type of device that allows data to be input or output from the computing device 300. For example, the external device 310 may be a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 310 may be integrated into the computing device 300. More than one external device may be in communication with the computing device 300.

The processing device 302 may be a programmable type, a dedicated, hardwired state machine, or a combination thereof. The processing device 302 may further include multiple processors, Arithmetic-Logic Units (ALUs), Central Processing Units (CPUs), Digital Signal Processors (DSPs), or Field-programmable Gate Arrays (FPGA), among other things. For forms of the processing device 302 with multiple processing units, distributed, pipelined, or parallel processing may be used. The processing device 302 may be dedicated to performance of just the operations described herein or may be used in one or more additional applications. The processing device 302 may be of a programmable variety that executes processes and processes data in accordance with programming instructions (such as software or firmware) stored in the memory device 306. Alternatively or additionally, programming instructions are at least partially defined by hardwired logic or other hardware. The processing device 302 may be comprised of one or more components of any type suitable to process the signals received from the input/output device 304 or elsewhere, and provide desired output signals. Such components may include digital circuitry, analog circuitry, or a combination thereof.

The memory device 306 in different embodiments may be of one or more types, such as a solid-state variety, electromagnetic variety, optical variety, or a combination of these forms, to name but a few examples. Furthermore, the memory device 306 may be volatile, nonvolatile, transitory, non-transitory or a combination of these types, and some or all of the memory device 306 may be of a portable variety, such as a disk, tape, memory stick, or cartridge, to name but a few examples. In addition, the memory device 306 may store data which is manipulated by the processing device 302, such as data representative of signals received from or sent to the input/output device 304 in addition to or in lieu of storing programming instructions, among other things. As shown in FIG. 3, the memory device 306 may be included with the processing device 302 or coupled to the processing device 302, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

1. A method for monitoring an industrial facility, comprising:
dividing an incident report into a plurality of text portions;
assigning a plurality of text confidence values to the plurality of text portions;
determining a report characteristic including a non-textual data type for the incident report;
training a neural network model;
inputting the plurality of text confidence values and the report characteristic into the neural network model; and
outputting a network confidence value from the neural network model in response to inputting the plurality of text confidence values and the report characteristic.

2. The method of claim 1, wherein assigning the plurality of text confidence values includes:
dividing one of the plurality of text portions into a plurality of phrases;
determining a plurality of abnormal condition scores to the plurality of phrases; and
determining the text confidence value for the one text portion using the abnormal condition scores.

3. The method of claim 1, wherein determining the report characteristic including the non-textual data type includes determining the report characteristic using the incident report.

4. The method of claim 3, wherein the non-textual data type includes at least one of a Boolean value, a categorical value, or an identification value.

5. The method of claim 1, comprising:
determining a flag status for the incident report after comparing the network confidence value and a flag threshold, and comparing the plurality of text confidence values and a plurality of flag thresholds.

6. The method of claim 1, comprising:
determining a flag status for the incident report using a weighted expression or a logical expression including the network confidence value and the plurality of text confidence values.

7. The method of claim 1, comprising:
generating a user interface including a plurality of visual representations corresponding to the plurality of text confidence values and the network confidence value, each visual representation indicating a flag status of the corresponding confidence value.

8. The method of claim 1, wherein training the neural network model uses historical text confidence values, historical report characteristics, and historical network confidence values.

9. The method of claim 1, wherein assigning the plurality of text confidence values to the plurality of text portions includes using a Bayesian confidence score.

10. The method of claim 1, comprising:
determining a plurality of report characteristics, each including a non-textual data type, at least one of the report characteristics being a non-normalized numerical value, at least one of the report characteristics being a normalized numerical value, and at least one of the report characteristics being a categorical value represented by one hot encoding.

11. A computer program product for use on a computer system monitoring an industrial facility, the computer program product comprising a tangible, non-transient computer usable medium including computer readable program code thereon, the computer readable program code comprising:
program code for dividing an incident report into a plurality of text portions;
program code for assigning a plurality of text confidence values to the plurality of text portions;
program code for determining a report characteristic including a non-textual data type for the incident report;
program code for training a neural network model;
program code for inputting the plurality of text confidence values and the report characteristic into the neural network model; and
program code for outputting a network confidence value from the neural network model in response to inputting the plurality of text confidence values and the report characteristic.

12. The computer program product of claim 11, wherein assigning the plurality of text confidence values includes:
dividing one of the plurality of text portions into a plurality of phrases;
determining a plurality of abnormal condition scores to the plurality of phrases; and
determining the text confidence value for the one text portion using the abnormal condition scores.

13. The computer program product of claim 11, wherein determining the report characteristic including the non-textual data type includes determining the report characteristic using the incident report.

14. The computer program product of claim 13, wherein the non-textual data type includes at least one of a Boolean value, a categorical value, or an identification value.

15. The computer program product of claim 11, comprising:
program code for determining a flag status for the incident report after comparing the network confidence value and a flag threshold, and comparing the plurality of text confidence values and a plurality of flag thresholds.

16. The computer program product of claim 11, comprising:
program code for determining a flag status for the incident report using a weighted expression or a logical expression including the network confidence value and the plurality of text confidence values.

17. The computer program product of claim 11, comprising:
program code for generating a user interface including a plurality of visual representations corresponding to the plurality of text confidence values and the network confidence value, each visual representation indicating a flag status of the corresponding confidence value.

18. The computer program product of claim 11, wherein training the neural network model uses historical text confidence values, historical report characteristics, and historical network confidence values.

19. The computer program product of claim 11, wherein assigning the plurality of text confidence values to the plurality of text portions includes using a Bayesian confidence score.

20. The computer program product of claim 11, comprising:
program code for determining a plurality of report characteristics, each including a non-textual data type, at least one of the report characteristics being a non-normalized numerical value, at least one of the report characteristics being a normalized numerical value, and at least one of the report characteristics being a categorical value represented by one hot encoding.
